(19) United States
(12) Patent Application Publication
(10) Pub. No.: US 2026/0103559 A1
(43) Pub. Date: Apr. 16, 2026

(54) Process for Preparing Polyether-Containing Thermoplastic Polyurethanes

(71) Applicant: Covestro Deutschland AG, Leverkusen (DE)

(72) Inventors: Yi Shen, Dormagen (DE); Franz-Heinrich Hermanns, Grevenbroich (DE); Michael Kessler, Leverkusen (DE)

(21) Appl. No.: 19/114,823

(22) PCT Filed: Sep. 21, 2023
(86) PCT No.: PCT/EP2023/076008

§ 371 Date: Mar. 25, 2025

(30) Foreign Application Priority Data
Sep. 26, 2022 (EP) 22197730.9

(51) Int. Cl. C08G 18/48; C08G 18/10; C08G 18/22; C08G 18/24

(52) U.S. Cl. CPC C08G 18/4837; C08G 18/10; C08G 18/222; C08G 18/244

(57) ABSTRACT

The present disclosure relates to a process for preparing polyether-containing thermoplastic polyurethanes and to polyether-containing thermoplastic polyurethanes obtained or obtainable by these processes. The disclosure further relates to the use of these polyether-containing thermoplastic polyurethanes and articles including or consisting of the polyether-containing thermoplastic polyurethane. The disclosure moreover relates to the use of a C3 polyether homopolymer polyol in combination with a C2 polyether homopolymer polyol and/or a C2/C3 polyether block copolymer polyol and/or C4 polyether homopolymer polyol, preferably of a C3 polyether homopolymer polyol in combination with a C2/C3 polyether block copolymer polyol, for increasing the low-temperature impact strength and/or the tensile strength of polyether-containing thermoplastic polyurethanes.

### CROSS-REFERENCE TO RELATED APPLICATIONS

This application is the United States national phase of International Patent Application No. PCT/EP2023/076008 filed Sep. 21, 2023, and claims priority to European Patent Application No. 22197730.9 filed Sep. 26, 2022, the disclosures of which are hereby incorporated by reference in their entireties.

### BACKGROUND

### Technical Field

The present invention relates to a process for preparing polyether-containing thermoplastic polyurethanes and to polyether-containing thermoplastic polyurethanes obtained or obtainable by these processes. The invention further relates to the use of these polyether-containing thermoplastic polyurethanes and articles comprising or consisting of the polyether-containing thermoplastic polyurethane. The invention moreover relates to the use of a C3 polyether homopolymer polyol in combination with a C2 polyether homopolymer polyol and/or a C2/C3 polyether block copolymer polyol and/or a C4 polyether homopolymer polyol, preferably of a C3 polyether homopolymer polyol in combination with a C2/C3 polyether block copolymer polyol, for increasing the low-temperature impact strength and/or the tensile strength of polyether-containing thermoplastic polyurethanes.

### Description of Related Art

Thermoplastic polyurethanes (TPUs) have long been known. They are of great industrial importance due to the combination of high-level mechanical properties with the known advantages of cost-effective thermoplastic processability. The use of different chemical building block components makes it possible to achieve a great breadth of variation in mechanical properties. An overview of TPUs, their properties and applications is described for example in Kunststoffe 68 (1978), pages 819 to 825, or Kautschuk, Gummi, Kunststoffe 35 (1982), pages 568 to 584. TPUs are formed from linear polyols, usually polyethers or polyesters, organic diisocyanates and short-chain diols (chain extenders). TPUs are typically solvent-free and can be prepared continuously or batchwise. The best-known industrial preparation processes which are also in use industrially are the belt process (GB 1057018 A) and the extruder process (DE 1964834 A-1 and DE 2059570 A-1).

To adjust the properties, the formation components can be varied within relatively broad molar ratios. Molar ratios of macrodiols to chain extenders of from 1:1 to 1:12 have proven useful. The hardness of the TPUs can be adjusted within a wide range via the amount of chain extender. This results in products in the hardness range from about 40 Shore A to about 85 Shore D.

For the improvement of the processing behaviour, in particular the cycle time, of particular interest over the entire hardness range from about 40 Shore A to about 85 Shore D are those TPUs which in injection-moulded articles have a very high solidification rate after processing. In particular in the case of hard TPUs and soft TPUs, there are frequently problems with the chemical coupling of the hard and soft segment on account of excessively high differences in polarity between these phases. As a result, the overall potential of the mechanical properties and the processing properties can frequently not be fully exploited. There has been no shortage of attempts to eliminate these disadvantages by specific methods.

A process for preparing thermoplastically processable polyurethanes is described by W. Brauer et al. (EP-A 1757632). The homogeneity of the TPUs is improved by a multistage OH-prepolymer process. However, the improved homogeneity slows the solidification rate of the TPUs.

A process for preparing soft, readily demouldable thermoplastic polyurethane elastomers having low shrinkage is described by W. Brauer et al. (EP-A 1338614). By pre-extending the soft segment, the demoulding behaviour of TPUs between 45 Shore A and 65 Shore A was improved. At very high hardnesses this process has clear disadvantages because incompatibilities between the hard and soft phase arise and hence good coupling between these phases can no longer take place. As a result, the high molecular weight of the TPUs which is required for good mechanical properties is not achieved. In practice, this process is also very unstable as a result of excessively high and fluctuating viscosities of the prepolymer stage and below 60 Shore A no longer functions satisfactorily, meaning extruder downtimes frequently occur.

To improve the low-temperature impact strength of polyester-based TPUs for ski boot applications for example, polyether polyols having a molecular weight of greater than 1600 g/mol, for example polytetramethylene ether glycol (U.S. Pat. No. 4,980,445A) and polypropylene diol ether (WO/2018/158327), are used as modifiers. Due to the incompatibilities between the hard and soft phase in the TPU, which leads to poor coupling of these phases, such polyethers can be incorporated as a pure soft phase into TPUs harder than 60 Shore D only with difficulty. A hard TPU with good low-temperature impact strength is difficult to prepare without a modifier.

The use of polypropylene glycol or poly(propylene oxide) homopolymers (hereinafter also referred to as C3 polyether homopolymer polyol) as polyol component in the preparation of thermoplastic polyurethanes is of interest, among other reasons, because of the low costs as starting material. The use of polypropylene glycol in the preparation of thermoplastic polyurethanes is known for example from WO 2020/109566 A1, where polyols based on polypropylene glycol are reacted with polyisocyanates.

However, a disadvantage with the use of polypropylene glycol as polyol component is that only thermoplastic polyurethanes having relatively low Shore A or theoretical hardnesses can be synthesized having sufficient mechanical properties and abrasion resistances. Hard thermoplastic polyurethanes based on polypropylene glycol usually exhibit these typical properties only to a minor degree, if at all, and are therefore unsuitable for applications in which much harder materials are required. Furthermore, this type of thermoplastic polyurethanes exhibit a minor low-temperature impact strength, as a result of which an application for articles that are also exposed to low temperatures is also no longer possible.

### SUMMARY

### Problem Addressed by the Disclosure

The problem addressed by the present invention was therefore that of providing a process for preparing polyether-containing thermoplastic polyurethanes having improved mechanical properties, in particular having increased hardnesses or increased tensile strength and/or low-temperature impact strength. In particular, the aim is to provide a process for the cost-effective preparation of polyether-containing thermoplastic polyurethanes that has an improved CO₂ balance.

### Solution

This problem is solved by a process for preparing polyether-containing thermoplastic polyurethanes by reacting a composition, comprising or consisting of the following components:
(A) at least one polyether homopolymer polyol,
(B) at least one polyisocyanate,
(C) at least one chain extender,
(D) optionally a catalyst,
(E) optionally at least one additive, auxiliary and/or addition,
   characterized in that
   the polyether homopolymer polyol is a C3 polyether homopolymer polyol (A1) and component (A) additionally contains at least one component (A2), comprising or consisting of a C2 polyether homopolymer polyol and/or a C2/C3 polyether block copolymer polyol and/or a C4 polyether homopolymer polyol, wherein the ratio by mass of component (A1) to (A2) is from 95:5 to 25:75, based on the total mass of components (A1) and (A2).

The invention further relates to a polyether-containing thermoplastic polyurethane obtained or obtainable by the process according to the invention.

The invention moreover relates to the use of the polyether-containing thermoplastic polyurethane according to the invention for the production of injection-moulded articles; extruded articles; pressed articles; compression-moulded articles; 3D printed articles; articles for mechanical engineering, road construction and rail construction; medical and dental articles, especially aligners for treating misaligned teeth; shoes, especially ski boots; articles for the automotive industry; articles for the electrical industry, especially cable sheathings, housings and plug connectors; consumer articles; coatings; hoses; profiles; belts; films; fibres; nonwovens; textiles; damping elements; sealing elements.

The invention further relates to an article comprising or consisting of the polyether-containing thermoplastic polyurethane according to the invention, wherein the article is preferably a ski boot.

The invention lastly relates to the use of
a C3 polyether homopolymer polyol in combination with a C2 polyether homopolymer polyol and/or a C2/C3 polyether block copolymer polyol and/or a C4 polyether homopolymer polyol
for increasing the Charpy impact strength and/or the tensile strength of polyether-containing thermoplastic polyurethanes, especially of polyether-containing thermoplastic polyurethanes according to the invention, wherein the low-temperature impact strength is determined in particular as the Charpy impact strength.

It has surprisingly been found that when the polyether homopolymer polyol in the preparation of polyether-containing thermoplastic polyurethanes is a C3 polyether homopolymer polyol, the mechanical properties, in particular the hardness or the tensile strength and/or the low-temperature impact strength, of these polyurethanes can be improved by the additional use, alongside the C3 polyether homopolymer polyol, of C2 polyether homopolymer polyols and/or C2/C3 polyether block copolymer polyols and/or C4 polyether homopolymer polyols.

In the context of this invention, a C2 polyether homopolymer polyol is understood to be a polyol based on polyethylene glycol or poly(ethylene oxide), a C3 polyether homopolymer polyol is understood to be a polyol based on polypropylene glycol or poly(propylene oxide), a C2/C3 polyether block copolymer polyol is understood to be a polyol based on polyethylene glycol or poly(ethylene oxide) and polypropylene glycol or poly(propylene oxide), and a C4 polyether homopolymer polyol is understood to be a polyol based on polytetramethylene glycol. The “C” in “C2”, “C3”, etc. stands for carbon atom, where the number following it indicates the number of carbon atoms in the repeat/repeating unit of the respective polymer.

It is particularly preferable for the polyether homopolymer polyol to be a C3 polyether homopolymer polyol (A1).

The process according to the invention can be conducted batchwise or continuously, with preference being given to a continuous process regime in particular on an industrial scale (for example as an inline one-shot process). It is also preferable for the process to additionally be conducted solventlessly. Examples of further possible synthesis processes include what is known as the prepolymer process, MDI splitting or the 3-stage equivalence prepolymer process, which are known in general to those skilled in the art.

In the process according to the invention, preferably the
C2 polyether homopolymer polyol has a number-average molecular weight in the range from 500 to 4000 g/mol, preferably 1000 to 3000 g/mol;
C3 polyether homopolymer polyol has a number-average molecular weight in the range from 500 to 8000 g/mol, preferably 1000 to 4500 g/mol;
C2/C3 polyether block copolymer polyol has a number-average molecular weight in the range from 1000 to 4000 g/mol, preferably 1500 to 2500 g/mol; and/or
C4 polyether homopolymer polyol has a number-average molecular weight in the range from 500 to 4500 g/mol, preferably 1500 to 4500 g/mol.

In a further embodiment of the process according to the invention, the theoretical hardness of the polyether-containing thermoplastic polyurethane is ≥40%, the theoretical hardness being calculated by the following formula:

theoretical hardness=(n(chain extender)*M(polyisocyanate)+m(chain extender))/mₜₒₜₐₗ

with n=molar amounts of the components, M=molar mass of the components and m=masses of the components.

In the context of the invention, it is further preferable for the molar ratio of the ethylene oxide units to propylene oxide units in the C2/C3 polyether block copolymer polyol to be 95:5 to 5:95, preferably 80:20 to 20:80, based on the molar amounts of the alkylene oxides used during the polyether preparation.

It is additionally preferable for the ratio by mass of component (A1) to (A2) to be from 65:35 to 30:70, based on the total mass of components (A1) and (A2).

It is moreover preferable for the polyisocyanate of component (B) to comprise or consist of diphenylmethane 4,4′-diisocyanate, diphenylmethane 2,4′-diisocyanate, diphenylmethane 2,2′-diisocyanate, hexamethylene 1,6-diisocyanate, toluene 2,4-diisocyanate, toluene 2,6-diisocyanate, isophorone diisocyanate, naphthylene 1,5-diisocyanate, 1,1′-methylenebis(4-isocyanatocyclohexane) or mixtures thereof, preferably diphenylmethane 4,4′-diisocyanate, diphenylmethane 2,4′-diisocyanate, diphenylmethane 2,2′-diisocyanate or mixtures thereof.

Preferably, the chain extender of component (C) is selected from the group comprising or consisting of ethane-1,2-diol, propane-1,2-diol, propane-1,3-diol, butane-1,4-diol, pentane-1,5-diol, hexane-1,6-diol, 1,4-di(beta-hydroxyethyl)hydroquinone, triethylene glycol, tetraethylene glycol or mixtures thereof, preferably ethane-1,2-diol, butane-1,4-diol, hexane-1,6-diol, triethylene glycol or mixtures thereof.

Catalysts (D) that may be used include the customary catalysts known from polyurethane chemistry. Suitable catalysts are customary tertiary amines known per se, for example triethylamine, dimethylcyclohexylamine, N-methylmorpholine, N,N′-dimethylpiperazine, 2-(dimethylaminoethoxy)ethanol, diazabicyclo [2.2.2]octane and the like, and also in particular organic metal compounds such as titanic esters, iron compounds, bismuth compounds, tin compounds, for example tin diacetate, tin dioctoate, tin dilaurate or the dialkyltin salts of aliphatic carboxylic acids such as dibutyltin diacetate, dibutyltin dilaurate or the like. Preferred catalysts are organic metal compounds, in particular titanic esters, iron compounds or tin compounds. Very particular preference is given to dibutyltin dilaurate, tin dioctoate and titanic esters.

Additives, auxiliaries and additions (E) that may be used are for example lubricants, such as fatty acid esters, metal soaps thereof, fatty acid amides and silicone compounds, antiblocking agents, inhibitors, stabilizers against hydrolysis, light, heat and discolouration, flame retardants, dyes, pigments, inorganic or organic fillers, nucleating agents and reinforcers and also monofunctional chain terminators. Reinforcers are especially fibrous reinforcing materials such as inorganic fibres, which are produced according to the prior art and may also be sized. As monofunctional chain terminators, monoalcohols, such as for example 1-butanol, 1-hexanol, 1-octanol and stearyl alcohol, or monoamines, such as for example 1-butylamine and stearylamine may be used in order to set a particular TPU molecular weight. Further details of the auxiliaries and additives mentioned can be found in the specialist literature, for example J. H. Saunders, K. C. Frisch: “High Polymers”, volume XVI, Polyurethanes, parts 1 and 2, Interscience Publishers 1962 and 1964, R. Gächter, H. Müller (eds.): Taschenbuch der Kunststoff-Additive [Handbook of Plastics Additives], 3rd edition, Hanser Verlag, Munich 1989, or DE-A 29 01 774.

It is further preferable for the process to comprise or consist of the following steps:
i) reacting a mixture made up of the total amount of component (A), a portion of component (B) and optionally a portion or the total amount of component (D) and/or component (E), to give an NCO-functional prepolymer, wherein there is a molar ratio of (partial) component (B) to component (A) of in the range from 1.1:1.0 to 5.0:1.0;
ii) reacting the NCO-functional prepolymer from step i) with the total amount of component (C) to obtain an OH-functional prepolymer, optionally in the presence of a further portion or the remaining amount of component (D) and/or (E);
iii) reacting the OH-functional prepolymer from step ii) with the remaining amount of component (B) and if applicable the remaining amount of component (D) and/or (E) to obtain the polyether-containing thermoplastic polyurethane,
   wherein in step ii) there is preferably a molar ratio of NCO-functional groups to OH-functional groups in component (C) of less than 1.0.

The reaction is preferably conducted at an isocyanate index of from 0.9 to 1.2, more preferably from 0.95 to 1.1, particularly preferably from 0.97 to 1.03. The isocyanate index (also called index or NCO/OH index) is understood here to mean the quotient of the molar amount [mol] of isocyanate groups actually used and the molar amount [mol] of isocyanate-reactive groups actually used. In other words, the index indicates the percentage ratio of the amount of isocyanate actually used to the stoichiometric amount of isocyanate, i.e. the amount calculated for the conversion of the OH equivalents. An equivalent amount of NCO groups and NCO-reactive hydrogen atoms corresponds to an NCO/OH index of 1 here. The isocyanate index is calculated here by the following formula:

index=[(moles of isocyanate groups)/(moles of isocyanate-reactive groups)]

The polyether-containing thermoplastic polyurethane according to the invention preferably has
a tensile strength of at least 17 MPa, preferably at least 22 to 60 MPa, measured according to ISO 53504 (2009-10); and/or
a Charpy impact strength of at least 30 KJ/m², preferably 50 to 140 KJ/m², measured at −20° C. according to DIN EN ISO179/1eA (2010).

The Charpy impact strength, measured at −20° C. according to DIN EN ISO179/1eA (2010), is understood in the context of the present invention as a measure of the low-temperature impact strength. Charpy impact strength tests are conducted on the injection-moulded specimens according to DIN EN ISO179/1eA (2010) at −20° C. The test specimen has the following dimensions: 80±2 mm length, 10.0±0.2 mm width and 4.0±0.2 mm thickness. The test specimen is notched. The notch base radius rN is 0.25±0.05 mm.

### DETAILED DESCRIPTION

The present invention especially relates to the following embodiments:

In a first embodiment, the invention relates to a process for preparing polyether-containing thermoplastic polyurethanes by reacting a composition, comprising or consisting of the following components:
(A) at least one polyether homopolymer polyol,
(B) at least one polyisocyanate,
(C) at least one chain extender,
(D) optionally a catalyst,
(E) optionally at least one additive, auxiliary and/or addition,
   characterized in that
   the polyether homopolymer polyol is a C3 polyether homopolymer polyol (A1) and component (A) additionally contains at least one component (A2), comprising or consisting of a C2 polyether homopolymer polyol and/or a C2/C3 polyether block copolymer polyol and/or a C4 polyether homopolymer polyol, wherein the ratio by mass of component (A1) to (A2) is from 95:5 to 25:75, based on the total mass of components (A1) and (A2).

In a second embodiment, the invention relates to a process according to Embodiment 1, characterized in that the
C2 polyether homopolymer polyol has a number-average molecular weight in the range from 500 to 4000 g/mol, preferably 1000 to 3000 g/mol;
C3 polyether homopolymer polyol has a number-average molecular weight in the range from 500 to 8000 g/mol, preferably 1000 to 4500 g/mol;
C2/C3 polyether block copolymer polyol has a number-average molecular weight in the range from 1000 to 4000 g/mol, preferably 1500 to 2500 g/mol; and/or
C4 polyether homopolymer polyol has a number-average molecular weight in the range from 500 to 4500 g/mol, preferably 1500 to 4500 g/mol.

In a third embodiment, the invention relates to a process according to Embodiment 1 or 2, characterized in that the theoretical hardness of the polyether-containing thermoplastic polyurethane is ≥40%, the theoretical hardness being calculated by the following formula:

$$theoretical hardness = ( n ( chain extender ) * M ( polyisocyanate ) + m ( chain extender ) ) / {m}_{total}$$

with n=molar amounts of the components, M=molar mass of the components and m=masses of the components.

In a fourth embodiment, the invention relates to a process according to any of the preceding embodiments, characterized in that the molar ratio of the ethylene oxide units to propylene oxide units in the C2/C3 polyether block copolymer polyol is 95:5 to 5:95, preferably 80:20 to 20:80, based on the molar amounts of the alkylene oxides used during the polyether preparation.

In a fifth embodiment, the invention relates to a process according to any of the preceding embodiments, characterized in that the ratio by mass of component (A1) to (A2) is from 65:35 to 30:70, based on the total mass of components (A1) and (A2).

In a sixth embodiment, the invention relates to a process according to any of the preceding embodiments, characterized in that the polyisocyanate of component (B) comprises or consists of diphenylmethane 4,4′-diisocyanate, diphenylmethane 2,4′-diisocyanate, diphenylmethane 2,2′-diisocyanate, hexamethylene 1,6-diisocyanate, toluene 2,4-diisocyanate, toluene 2,6-diisocyanate, isophorone diisocyanate, naphthylene 1,5-diisocyanate, 1,1′-methylenebis(4-isocyanatocyclohexane) or mixtures thereof, preferably diphenylmethane 4,4′-diisocyanate, diphenylmethane 2,4′-diisocyanate, diphenylmethane 2,2′-diisocyanate or mixtures thereof.

In a seventh embodiment, the invention relates to a process according to any of the preceding embodiments, characterized in that the chain extender of component (C) is selected from the group comprising or consisting of ethane-1,2-diol, propane-1,2-diol, propane-1,3-diol, butane-1,4-diol, pentane-1,5-diol, hexane-1,6-diol, 1,4-di(beta-hydroxyethyl)hydroquinone, triethylene glycol, tetraethylene glycol or mixtures thereof, preferably ethane-1,2-diol, butane-1,4-diol, hexane-1,6-diol, triethylene glycol or mixtures thereof.

In an eighth embodiment, the invention relates to a process according to any of the preceding embodiments, characterized in that the additive, auxiliary and/or addition of component (E) is selected from the group comprising or consisting of lubricants, especially fatty acid esters, metal soaps thereof, fatty acid amides and silicone compounds; antiblocking agents; inhibitors; stabilizers; flame retardants; dyes; pigments; inorganic fillers; organic fillers; nucleating agents; reinforcers, especially inorganic fibres; monofunctional chain terminators, especially 1-butanol, 1-hexanol, 1-octanol, stearyl alcohol, 1-butylamine and stearylamine; or mixtures thereof.

In a ninth embodiment, the invention relates to a process according to any of the preceding embodiments, characterized in that the process comprises or consists of the following steps:
i) reacting a mixture made up of the total amount of component (A), a portion of component (B) and optionally a portion or the total amount of component (D) and/or component (E), to give an NCO-functional prepolymer, wherein there is a molar ratio of (partial) component (B) to component (A) in the range from 1.1:1.0 to 5.0:1.0;
ii) reacting the NCO-functional prepolymer from step i) with the total amount of component (C) to obtain an OH-functional prepolymer, optionally in the presence of a further portion or the remaining amount of component (D) and/or (E);
iii) reacting the OH-functional prepolymer from step ii) with the remaining amount of component (B) and if applicable the remaining amount of component (D) and/or (E) to obtain the polyether-containing thermoplastic polyurethane,
   wherein in step ii) there is preferably a molar ratio of NCO-functional groups to OH-functional groups in component (C) of less than 1.0.

In a tenth embodiment, the invention relates to a process according to any of the preceding claims, characterized in that the reaction is conducted at an isocyanate index of from 0.9 to 1.2, preferably from 0.95 to 1.1, more preferably from 0.97 to 1.03.

In an eleventh embodiment, the invention relates to a polyether-containing thermoplastic polyurethane obtained or obtainable by a process according to any of Embodiments 1 to 10.

In a twelfth embodiment, the invention relates to a polyether-containing thermoplastic polyurethane according to Embodiment 11, characterized in that the polyether-containing thermoplastic polyurethane has
a tensile strength of at least 17 MPa, preferably at least 22 to 60 MPa, measured according to ISO 53504 (2009-10); and/or
a Charpy impact strength of at least 30 KJ/m², preferably 50 to 140 KJ/m², measured at −20° C. according to DIN EN ISO179/1eA (2010).

In a thirteenth embodiment, the invention relates to the use of the polyether-containing thermoplastic polyurethane according to Embodiment 11 or 12 for the production of injection-moulded articles; extruded articles; pressed articles; compression-moulded articles; 3D printed articles; articles for mechanical engineering, road construction and rail construction; medical and dental articles, especially aligners for treating misaligned teeth; shoes, especially ski boots; articles for the automotive industry; articles for the electrical industry, especially cable sheathings, housings and plug connectors; consumer articles; coatings; hoses; profiles; belts; films; fibres; nonwovens; textiles; damping elements; sealing elements.

In a fourteenth embodiment, the invention relates to an article comprising or consisting of a polyether-containing thermoplastic polyurethane according to Embodiment 11 or 12, wherein the article is preferably a ski boot.

In a fifteenth embodiment, the invention relates to the use of
a C3 polyether homopolymer polyol in combination with a C2 polyether homopolymer polyol and/or a C2/C3 polyether block copolymer polyol and/or a C4 polyether homopolymer polyol for increasing the low-temperature impact strength and/or the tensile strength of polyether-containing thermoplastic polyurethanes, especially of polyether-containing thermoplastic polyurethanes according to Embodiment 11 or 12, wherein the low-temperature impact strength is determined in particular as the Charpy impact strength.

### EXAMPLES AND COMPARATIVE EXAMPLES

The present invention is elucidated hereinbelow with reference to examples, but is in no way limited to these.

### Components Used:

Polyol 1=polypropylene glycol (C3 polyether homopolymer polyol), starter propylene glycol (poly(propylene oxide) homopolymer); OH number approx. 56: proportion of secondary terminal OH groups: >90%;
Polyol 2=Terathane®2000 (commercial product from Invista: polytetramethylene glycol; OH number approx. 56), (C4 polyether homopolymer polyol);
Polyol 3=poly(propylene oxide)-poly(ethylene oxide) block copolymer (C2/C3 polyether block copolymer polyol): Propylene glycol (starter) with polymerized-on alkylene oxides (molar ratio of ethylene oxide units to propylene oxide units of approx. 51:49); OH number approx. 56, proportion of primary terminal OH groups: >90%), KOH catalysed
Polyol 4=polypropylene glycol (C3 polyether homopolymer polyol), starter propylene glycol (poly(propylene oxide) homopolymer), OH number approx. 28: proportion of secondary terminal OH groups: >90%)
BDO=butane-1,4-diol (BDO, purity ≥99% by weight) was sourced from Ashland.
TEG=triethylene glycol (TEG, purity ≥95% by weight) was sourced from Thermo Fischer (Kandel) GmbH.
MDI=diphenylmethane 4,4′-diisocyanate (MDI, purity ≥99% by weight) was sourced from Covestro AG.

### Measurement Methods Used:

OH numbers titrated in accordance with DIN 53240-2:2007-11
Tensile test: Measurement in accordance with ISO 53504 (2009-10) at a pulling rate of 200 mm/min;
Charpy impact strength testing (low-temperature impact strength): Charpy impact strength tests were conducted on the injection moulded specimens according to DIN EN ISO179/1eA (2010) at −20° C. The test specimen has the following dimensions: 80±2 mm length, 10.0±0.2 mm width and 4.0±0.2 mm thickness. The test specimen is notched. The notch base radius rN is 0.25±0.05 mm.

### Examples

Table 1 illustrates the invention on the basis of a few examples. The preparation processes used are described hereinbelow.

### Preparation (Batchwise Process):

Step 1: Portion 1 (see Table 1) of the MDI is reacted with 1 mol of polyol or polyol mixture with stirring at approx. 140° C. up to a conversion of >90 mol %, based on the polyol.

Step 2: The chain extender is added to the stirred reaction mixture and this is stirred intensively for approx. 10 s.

Step 3: Portion 2 (see Table 1) of the MDI is added to the stirred reaction mixture. The reaction mixture is stirred for a further 20 s, and then poured onto a metal sheet and heat-treated at 120° C. for 30 minutes.

The TPU cast sheets obtained were chopped and pelletized. The pellets were processed using an Arburg Allrounder 470S injection-moulding machine in a temperature range of 180° to 230° C. and in a pressure range of 650 to 750 bar at an injection rate of 10 to 35 cm3/s to give bars (mould temperature: 40° C.; bar size: 80×10×4 mm) or slabs (mould temperature: 70° C.; size: 125×50×2 mm).

The mechanical values (tensile strength and tensile elongation) and the Charpy low-temperature impact strength of the TPU products produced were determined.

Examples 1-18 describe batchwise processes.

Preparation (Continuous Process, e.g. Reactive Extruder):

Analogously to the batchwise experiments, the TPU can also be prepared batchwise, for example using a twin-screw reactive extruder (however, the preparation is not limited to this presentation form, see “belt process”).

A gear pump was used to meter portion 1 of the MDI, preheated to 60° C., into a tube equipped with a pin mixer. A second gear pump was used to pump a polyol or polyol mixture, heated to 140° C., into the same tube. The tube had a length/diameter ratio of 8:1. The reaction mixture flowed continuously into a connected twin-screw extruder that was heated externally to 140° C. to 220° C. The chain extender and portion 2 of the MDI were added in the middle of the screw. The speed of the screw shaft was 300 rpm. At the end of the screw, the hot melt was pelletized and cooled. The pellets were processed by injection moulding into test specimens of which the properties listed in the table were measured.

Example 19 describes a continuous process (extruder process).

TABLE 1

| | Polyol | | | MDI | MDI | Tensile | Tensile | |
|---|---|---|---|---|---|---|---|---|
| Experiment | (ratio by | Chain | Theor. | portion | portion | strength | elongation | Charpy |
| number | mass) | extender | hardness^{#} | 1 [mol] | 2 [mol] | [MPa] | [%] | [−20°] |
| 1* | 1 | TEG/BDO | 58 | 2 | 7.8 | ** | ** | ** |
| | | 20/80 | | | | | | |
| 2 | 1/2 (70/30) | TEG/BDO | 58 | 2 | 7.8 | 26.2 | 198 | 103 |
| | | 20/80 | | | | | | |
| 3* | 3 | BDO | 58 | 2 | 8.1 | 38.8 | 361 | 15.6 |
| 4 | 3/1 (70/30) | TEG/BDO | 58 | 2 | 7.8 | 26.6 | 237 | 124 |
| | | (20/80) | | | | | | |
| 5* | 3 | BDO | 62 | 2 | 9.8 | 24.1 | 285 | 12.6 |
| 6* | 3 | BDO | 66 | 2 | 11.9 | 31.1 | 233 | 5.93 |
| 7* | 3 | BDO | 70 | 2 | 14.5 | 37.9 | 127 | 4.47 |
| 8 | 3/1 (65/35) | BDO | 58 | 2 | 8.1 | 29.7 | 244 | 112.6 |
| 9 | 3/1 (65/35) | BDO | 62 | 2 | 9.8 | 36.1 | 217 | 70.6 |
| 10 | 3/1 (50/50) | BDO | 58 | 2 | 8.1 | 25.9 | 213 | 95.3 |
| 11 | 3/1 (50/50) | BDO | 62 | 2 | 9.8 | 30.9 | 159 | 52.5 |
| 12 | 3/1 (30/70) | BDO | 58 | 2 | 8.1 | 22.2 | 160 | 81.5 |
| 13 | 3/1 (30/70) | BDO | 62 | 2 | 9.8 | 23.9 | 99 | 58.8 |
| 14* | 3/1 (80/20) | BDO | 58 | 2 | 8.1 | 26.7 | 287 | 21 |
| 15 | 3/1 (60/40) | BDO | 58 | 2 | 8.1 | 37.2 | 255 | 98 |
| 16 | 3/4(60/40) | BDO | 58 | 2 | 10.2 | 36 | 203 | 103 |
| 17 | 3/1 (60/40) | BDO | 62 | 2 | 9.8 | 35.3 | 174 | 122 |
| 18* | 1 | BDO | 58 | 2 | 8.1 | ** | ** | ** |
| 19 | 3/1 (60/40) | BDO | 58 | 2 | 8.1 | 32 | 195 | 119 |

*comparative example not in accordance with the invention;
** unable to be processed;
^{#}theor. hardness (=theoretical hardness or TH) is the proportion by weight of the hard segment in the TPU: TH = (n(CE)*M(ISO) + m(CE))/mₜₒₜ with CE = chain extender and ISO = isocyanate (here MDI)

Comparative examples 1 and 18 are TPU formulations based on polypropylene glycol (C3 polyether homopolymer polyol), the TPUs cannot be produced and/or cannot be processed by injection moulding.
Comparative examples 3 and 5-7 are formulations based on polypropylene-polyethylene glycol (C2/C3 polyether block copolymer polyol), the TPUs can be produced with good tear strength but have poor low-temperature impact strength.
Examples 4, 8-13 and 15-17 show TPU formulations with C2/C3 polyether block copolymer polyol mixed with C3 polyether homopolymer polyol having good tear strength and good low-temperature impact strength (Charpy impact strength).
Comparative example 14 shows a TPU formulation based on C2/C3 polyether block copolymer polyol mixed with polypropylene glycol (C3 polyether homopolymer polyol) in a ratio of about 80:20; the material exhibits good tear strengths but not satisfactory low-temperature impact strength.
Example 2 shows a TPU formulation based on C3 ether polyol and a C4 polyether homopolymer polyol (also polyTHF or PTMEG) having good mechanical properties and good low-temperature impact strength.
Example 19 shows that the process according to the invention in the context of a continuous process regime also leads to a good tear strength with simultaneously good low-temperature impact strength of the polyether-containing thermoplastic polyurethane prepared.

1. A process for preparing polyether-containing thermoplastic polyurethanes by reacting a composition, comprising or consisting of the following components:
(A) at least one polyether homopolymer polyol,
(B) at least one polyisocyanate,
(C) at least one chain extender,
(D) optionally a catalyst,
(E) optionally at least one additive, auxiliary and/or addition,
wherein
the polyether homopolymer polyol is a C3 polyether homopolymer polyol (A1) and component (A) additionally contains at least one component (A2), comprising or consisting of a C2 polyether homopolymer polyol and/or a C2/C3 polyether block copolymer polyol and/or a C4 polyether homopolymerpolyol, wherein a ratio by mass of component (A1) to (A2) is from 95:5 to 25:75, based on the total mass of components (A1) and (A2).

2. The process according to claim 1, wherein the
C2 polyether homopolymer polyol has a number-average molecular weight in the range from 500 to 4000 g/mol;
C3 polyether homopolymer polyol has a number-average molecular weight in the range from 500 to 8000 g/mol;
C2/C3 polyether block copolymer polyol has a number-average molecular weight in the range from 1000 to 4000 g/mol; and/or
C4 polyether homopolymer polyol has a number-average molecular weight in the range from 500 to 4500 g/mol.

3. The process according to claim 1, wherein the theoretical hardness of the polyether-containing thermoplastic polyurethane is ≥40%, the theoretical hardness being calculated by the following formula:
$$theoretical hardness = ( n ( chain extender ) * M ( polyisocyanate ) + m ( chain extender ) ) / {m}_{total}$$
with n=molar amounts of the components, M=molar mass of the components and m=masses of the components.

4. The process according to claim 1, wherein the molar ratio of the ethylene oxide units to propylene oxide units in the C2/C3 polyether block copolymer polyol is 95:5 to 5:95, based on the molar amounts of the alkylene oxides used during the polyether preparation.

5. The process according to claim 1, wherein the ratio by mass of component (A1) to (A2) is from 65:35 to 30:70, based on the total mass of components (A1) and (A2).

6. The process according to claim 1, wherein the polyisocyanate of component (B) comprises or consists of diphenylmethane 4,4′-diisocyanate, diphenylmethane 2,4′-diisocyanate, diphenylmethane 2,2′-diisocyanate, hexamethylene 1,6-diisocyanate, toluene 2,4-diisocyanate, toluene 2,6-diisocyanate, isophorone diisocyanate, naphthylene 1,5-diisocyanate, 1,1′-methylenebis(4-isocyanatocyclohexane) or mixtures thereof.

7. The process according to claim 1, wherein the chain extender of component (C) is selected from the group comprising or consisting of ethane-1,2-diol, propane-1,2-diol, propane-1,3-diol, butane-1,4-diol, pentane-1,5-diol, hexane-1,6-diol, 1,4-di(beta-hydroxyethyl)hydroquinone, triethylene glycol, tetraethylene glycol or mixtures thereof.

8. The process according to claim 1, wherein the additive, auxiliary and/or addition of component (E) is selected from the group comprising or consisting of lubricants; antiblocking agents; inhibitors; stabilizers; flame retardants; dyes; pigments; inorganic fillers; organic fillers; nucleating agents; reinforcers; monofunctional chain terminators; or mixtures thereof.

9. The process according to claim 1, wherein the process comprises or consists of the following steps:
i) reacting a mixture made up of the total amount of component (A), a portion of component (B) and optionally a portion or the total amount of component (D) and/or component (E), to give an NCO-functional prepolymer, wherein there is a molar ratio of (partial) component (B) to component (A) in the range from 1.1:1.0 to 5.0:1.0;
ii) reacting the NCO-functional prepolymer from step i) with the total amount of component (C) to obtain an OH-functional prepolymer, optionally in the presence of a further portion or the remaining amount of component (D) and/or (E);
iii) reacting the OH-functional prepolymer from step ii) with the remaining amount of component (B) and if applicable the remaining amount of component (D) and/or (E) to obtain the polyether-containing thermoplastic polyurethane,
wherein in step ii) there is a molar ratio of NCO-functional groups to OH-functional groups in component (C) of less than 1.0.

10. The process according to claim 1, wherein the reaction is conducted at an isocyanate index of from 0.9 to 1.2.

11. A polyether-containing thermoplastic polyurethane obtained or obtainable by a process according to claim 1.

12. The polyether-containing thermoplastic polyurethane according to claim 11, wherein the polyether-containing thermoplastic polyurethane has
a tensile strength of at least 17 MPa, measured according to ISO 53504 (2009-10); and/or
a Charpy impact strength of at least 30 KJ/m², measured at −20° C. according to DIN EN ISO179/1eA (2010).

13. A method for the production of injection-moulded articles; extruded articles; pressed articles; compression-moulded articles; 3D printed articles; articles for mechanical engineering, road construction and rail construction; medical and dental articles, especially aligners for treating misaligned teeth; shoes, especially ski boots; articles for the automotive industry; articles for the electrical industry, especially cable sheathings, housings and plug connectors; consumer articles; coatings; hoses; profiles; belts; films; fibres; nonwovens; textiles; damping elements; sealing elements, the method comprising providing a polyether-containing thermoplastic polyurethane according to claim 11.

14. An article comprising or consisting of a polyether-containing thermoplastic polyurethane according to claim 11.

15. A method for increasing the low-temperature impact strength and/or the tensile strength of polyether-containing thermoplastic polyurethanes according to claim 11, wherein the low-temperature impact strength is determined in particular as the Charpy impact strength, the method comprising providing a C3 polyether homopolymer polyol in combination with a C2 polyether homopolymer polyol and/or a C2/C3 polyether block copolymer polyol and/or a C4 polyether homopolymer polyol.

16. The article according to claim 14, wherein the article is a ski boot.
